(19) United States
(12) Patent Application Publication
(10) Pub. No.: US 2008/0122717 A1
(43) Pub. Date: May 29, 2008

(54) Flat Miniaturized Antenna and Related Electronic Device Operated in Wide Band

(76) Inventors: Hsin-Lung Su, Taipei Hsien (TW); Wei-Shan Chang, Taipei Hsien (TW); Jiunn-Ming Huang, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/624,223

(22) Filed: Jan. 18, 2007

(30) Foreign Application Priority Data
Nov. 2, 2006 (TW) 095140576

(51) Int. Cl. H01Q 1/38; H01Q 1/00; H01Q 9/04

(52) U.S. Cl. 343/787; 343/700 MS

(57) ABSTRACT

A flat miniaturized antenna includes a substrate, a radiation element, a short circuit metal arm, and a feed element. The substrate includes a first sheet and a second sheet. The first sheet is perpendicular to the second sheet. The radiation element includes a first radiation plate approximately paralleling the first sheet, a second radiation plate approximately paralleling the first sheet and extended in a direction opposite to the first radiation plate, and a third radiation plate positioned between the second radiation plate and the first sheet and perpendicular to the second radiation plate. The short circuit metal arm is installed between the first radiation plate and the first sheet. The short circuit metal arm includes a start terminal coupled to the third radiation plate and an end terminal coupled to the substrate. The feed element is used for connecting the third radiation plate to the first sheet electrically.

### BACKGROUND OF THE INVENTION

1. Field of the Invention

The present invention relates to a flat miniaturized antenna operated in wide band, and more particularly, to a flat miniaturized antenna operated in wide band by adding a metal microstrip to resonate a bandwidth of a designated frequency.

2. Description of the Prior Art

As wireless telecommunication develops with the trend of micro-sized mobile communication products, the location and the space arranged for antennas are limited. Therefore, some built-in micro antennas have been developed. Currently, some micro antennas such as a chip antenna, a planar antenna and so on are commonly used. All these antennas have the feature of small volume. Additionally, planar antennas are also designed in many types such as microstrip antennas, printed antennas and planar inverted F antennas. These antennas are widespread applied to GSM, DCS, UMTS, WLAN, Bluetooth, etc. Please refer to FIG. 1. FIG. 1 is a diagram of a dual-frequency antenna 10 in the prior art. The dual-frequency antenna 10 includes a substrate 12, a radiation element 14, a connection element 16, and a feed element 18. The substrate 12 approximately is a rectangle, and has a first edge 122 and a second edge 123. The first edge 122 includes a short point 124 and a grounding point 126. The radiation element 14 is installed in the first edge 122. The radiation element 14 includes a first radiation plate 141 and a second radiation plate 142. The first radiation plate is a rectangle and parallels the first edge 122. The second radiation plate 142 is a rectangle. The second radiation plate 142 parallels the first edge 122 and is extended in a direction opposite to the first radiation plate 141. A length of the first radiation plate 141 is smaller than a length of the second radiation plate 142. The connection element is positioned between the radiation element 14 and the first edge 122 and includes a first section 161, a second section 162, and a third section 163. The first section 161 is coupled to the first radiation plate 141 and to the second radiation plate 142, the second section 162 is coupled to the short point 124 of the substrate 12, and the third section 163 is coupled between the first section 161 and the section 162. The first section 161 of the connection element 16 has a feed point 166 located adjacent to the first edge 122. The feed point 166 of the first section 161 is connected to the grounding point 126 of the first edge 122 through the feed element 18 electrically.

The dual-frequency antenna 10 is applied to wireless fidelity (Wi-Fi) and includes two operation bandwidths. The operation bandwidth of a first resonance mode generated by the dual-frequency antenna 10 is from about 5 GHz to 6 GHz, and the operation bandwidth of a second resonance mode generated by the dual-frequency antenna 10 is from about 2.4 GHz to 2.5 GHz. Due to the length of the first radiation plate 141 being smaller than the length of the second radiation plate 142, the first radiation plate 141 can resonate the operation bandwidth of the first resonance mode (5 GHz-6 GHz) and the second radiation plate 142 can resonate the operation bandwidth of the second resonance mode (2.4 GHz-2.5 GHz). A sum of a length of the first radiation plate 141 and a length of the first section 161 is approximately one-fourth of a wavelength of the first resonance mode. A sum of a length of the second radiation plate 142 and a length of the first section 161 is approximately one-fourth of a wavelength of the second resonance mode. The substrate 12 comprises dielectric material or magnetic material and is coupled to a system ground terminal. The radiation element 14 and the connection element 16 are each substantially composed of a single metal sheet.

Please refer to FIG. 2 and FIG. 1. FIG. 2 is a diagram illustrating the VSWR (voltage standing wave ratio) of the dual-frequency antenna 10 in FIG. 1. The horizontal axis represents frequency, and the vertical axis represents VSWR defined by an equation of VSWR=Vmax/Vmin. As shown in FIG. 2, all voltage gains fall under a dotted line of VSWR2:1 in frequencies adjacent to 2.5 GHz and 5 GHz-6 GHz and is satisfied with Wi-Fi. The dual-frequency antenna 10 could not provide enough bandwidth if other frequencies are required.

Several antennas with different frequencies are installed in a portable electronic device for receiving multifarious frequencies. The dual-frequency antenna 10 is capable of resonating the first resonance mode (5GHz-6GHz) and the second resonance mode (2.4 GHz-2.5 GHz) to fit in with operation bandwidths of Wi-Fi. Even so, the dual-frequency antenna 10 could not provide enough bandwidth if Wi-Max (worldwide interoperability for microware access) antennas become one of the master streams of wireless communication.

### SUMMARY OF THE INVENTION

The claimed invention provides a flat miniaturized antenna operated in wide band. The flat miniaturized antenna includes a substrate, a radiation element, a short circuit metal arm, and a feed element. The substrate includes a first sheet and a second sheet. The first sheet is perpendicular to the second sheet and incorporates a short point and a grounding point. The radiation element is installed on the first sheet and includes a first radiation plate, a second radiation plate, and a third radiation plate. The first radiation plate approximately parallels the first sheet. The second radiation plate approximately parallels the first sheet and is extended in a direction opposite to the first radiation plate. The third radiation plate is positioned between the second radiation plate and the first sheet and is perpendicular to the second radiation plate. The third radiation plate approximately is an L shape, and has a first side coupled to the first radiation plate and to the second radiation plate and a second side. The short circuit metal arm is installed between the first radiation plate and the first sheet. The short circuit metal arm has a start terminal coupled to the first side and to the second side of the third radiation plate, and an end terminal coupled to the short point of the substrate. The feed element is used for connecting the second side of the third radiation plate to the grounding point of the first sheet electrically. The second side of the third radiation plate comprises a feed point. The feed point is located adjacent to the first sheet and is coupled to the grounding point of the first sheet through the feed element. A joint of the first side and the second side of the third radiation plate forms a right angle, an oblique angle, or an arc.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a dual-frequency antenna in the prior art.

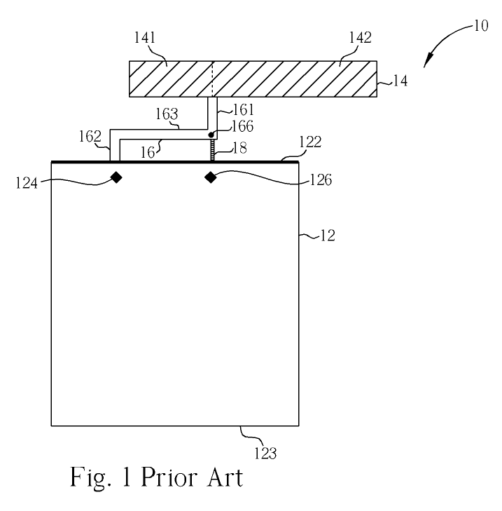

FIG. 2 is a diagram illustrating the VSWR of the dual-frequency antenna in FIG. 1.

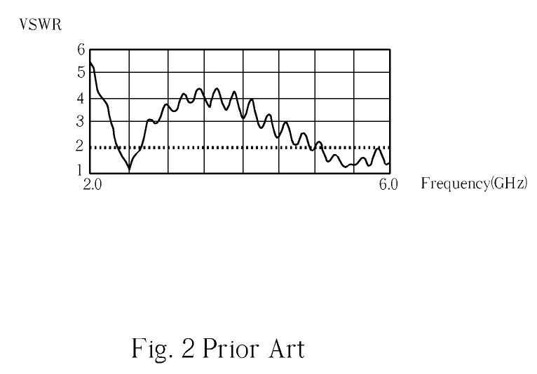

FIG. 3 is a diagram illustrating a flat miniaturized antenna operated in wide band according to an embodiment of the present invention.

FIG. 4 is a diagram illustrating the VSWR of the flat miniaturized antenna in FIG. 3.

FIG. 5 is a three-dimensional picture of the flat miniaturized antenna in FIG. 3.

FIG. 6 is a diagram illustrating a flat miniaturized antenna operated in wide band according to another embodiment of the present invention.

FIG. 7 is a diagram illustrating the VSWR of the flat miniaturized antenna in FIG. 6.

### DETAILED DESCRIPTION

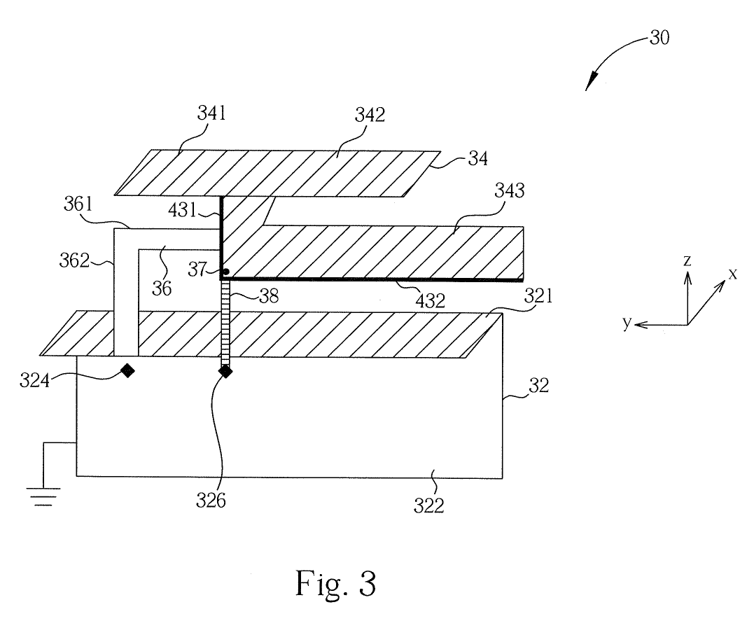

Please refer to FIG. 3 that is a diagram illustrating a flat miniaturized antenna 30 operated in wide band according to an embodiment of the present invention. The flat miniaturized antenna 30 includes a substrate 32, a radiation element 34, a short circuit metal arm 36, and a feed element 38. The substrate 32 has a first sheet 321 and a second sheet 322. The first sheet 321 is perpendicular to the second sheet 322. The first sheet 321 of the substrate 32 includes a short point 324 and a grounding point 326. The radiation element 34 is installed on the first sheet 321 and includes a first radiation plate 341, a second radiation plate 342, and a third radiation plate 343. The first radiation plate 341 is a rectangle and approximately parallels the first sheet 321. The second radiation plate 342 is a rectangle. The second radiation plate 342 approximately parallels the first sheet 321 and is extended in a direction opposite to the first radiation plate 341. The third radiation plate 343 is an L shape and positioned between the second radiation plate 342 and the first sheet 321. The third radiation plate 343 is perpendicular to the second radiation plate 342 and includes a first side 431 coupled to the first radiation plate 341 and to the second radiation plate 342 and a second side 432. A length of the first radiation plate 341 is smaller than a length of the second radiation plate 342. A length of the second side 432 of the third radiation plate 343 is greater than a sum of a length of the second radiation plate 342 and a length of the first side 431 of the third radiation plate 343. The short circuit metal arm 36 is installed between the first radiation plate 341 and the first sheet 321. The short circuit metal arm 36 has a start terminal 361 coupled to the first side 431 and to the second side 432 of the third radiation plate 343, and an end terminal 362 coupled to the short point 324 of the substrate 32. The feed element 38 is used for connecting the second side 432 of the third radiation plate 343 to the grounding point 326 of the first sheet 321 electrically. The second side 432 of the third radiation plate 343 comprises a feed point 37. The feed point 37 is located adjacent to the first sheet 321 and is coupled to the grounding point 326 of the first sheet 321 through the feed element 38.

Please keep referring to FIG. 3. The flat miniaturized antenna 30 is a multi-frequency antenna and can be applied to both Wi-Fi and Wi-Max. An operation bandwidth of a first resonance mode generated by the flat miniaturized antenna 30 is from about 5 GHz to 6 GHz, an operation bandwidth of a second resonance mode generated by the flat miniaturized antenna 30 is from about 2.4 GHz to 2.5 GHz (Wi-Fi), and an operation bandwidth of a third resonance mode is from about 2.3 GHz to 2.7 GHz and from about 3.3 GHz to 3.8 GHz (Wi-Max). A length of the first radiation plate 341 is smaller than a length of the second radiation plate 342. A length of the second side of the third radiation plate 343 is greater than a sum of a length of the second radiation plate 342 and a length of the first side 431 of the third radiation plate 343. The first radiation plate 341 can resonate the operation bandwidth of the first resonance mode (5 GHz-6 GHz), the second radiation plate 342 can resonate the operation bandwidth of the third resonance mode (3.3 GHz-3.8 GHz), and the third radiation plate 343 can resonate the operation bandwidth of the second resonance mode (2.3 GHz-2.7 GHz). A sum of a length of the first radiation plate 341 and a length of the first side 431 is approximately one-fourth of a wavelength of the first resonance mode generated by the flat miniaturized antenna 30. A sum of a length of the second radiation plate 342 and a length of the first side 431 is approximately one-fourth of a wavelength of the second resonance mode generated by the flat miniaturized antenna 30. A length of the second side 432 of the third radiation plate 343 is approximately one-fourth of a wavelength of the third resonance mode generated by the flat miniaturized antenna 30. Wherein the substrate 32 comprises dielectric material or magnetic material and is coupled to a system ground terminal. The radiation element 34 and the short circuit metal arm 36 is each substantially composed of a single metal sheet. The flat miniaturized antenna 30 is installed inside a housing of a wireless communication device, such as a notebook computer.

Please notice that the flat miniaturized antenna 30 has better impedance matching and can be implemented in restricted space easily according to experiment data due to an included angle between the third radiation plate 343 and the second radiation plate 342 that is 90 degrees. As the wireless telecommunication develops with the trend of micro-sized mobile communication product, the location and the space arranged for antennas are limited. Furthermore, the flat miniaturized antenna 30 is capable of tallying with mechanisms and has increased capacitor effect for better impedance matching due to the first radiation plate 341 paralleling the first sheet 321.

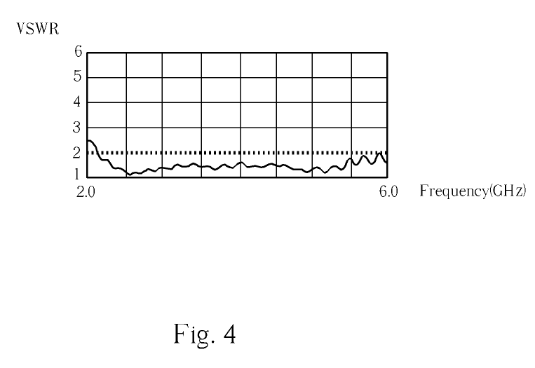

Please refer to FIG. 4 and FIG. 3. FIG. 4 is a diagram illustrating the VSWR of the flat miniaturized antenna 30 in FIG. 3. The horizontal axis represents frequency, and the vertical axis represents VSWR defined by an equation of VSWR=Vmax/Vmin. As shown in FIG. 4, all voltage gains fall under a dotted line of VSWR2:1 in frequencies adjacent to 2.5 GHz, 3.3 GHz, and 5 GHz-6 GHz. The flat miniaturized antenna 30 could provide enough bandwidth if other frequencies are required. In other words, the flat miniaturized antenna 30 is satisfied with both Wi-Fi and Wi-Max.

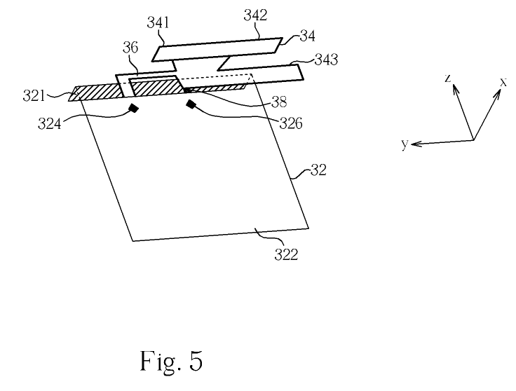

Please refer to FIG. 5 and FIG. 3. FIG. 5 is a three-dimensional picture of the flat miniaturized antenna 30 in FIG. 3. Seen from these three-dimensional axes X, Y, and Z: the first sheet 321 is located on the X-Y plane, the second sheet 322 is located on the Y-Z plane, the first radiation plate 341 and the second radiation plate 342 is located on the X-Y plane, the third radiation plate 343 is located on the Y-Z plane, and the short circuit metal arm 36 is located on the Y-Z plane.

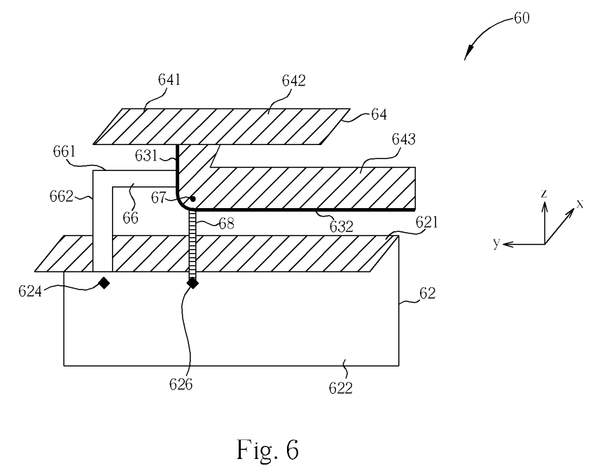

Please refer to FIG. 6 and FIG. 3. FIG. 6 is a diagram illustrating a flat miniaturized antenna 60 operated in wide band according to another embodiment of the present invention. The flat miniaturized antenna 60 includes a substrate 62, a radiation element 64, a short circuit metal arm 66, and a feed element 68. Please notice that the flat miniaturized antenna 60 is similar to the flat miniaturized antenna 30 and a difference between them is that a joint of the first side 631 and the second side 632 of the third radiation plate 643 forms an arc. However, as shown in FIG. 3, a joint of the first side 431 and the second side 432 of the third radiation plate 343 forms a right angle (forming an oblique angle is not limited).

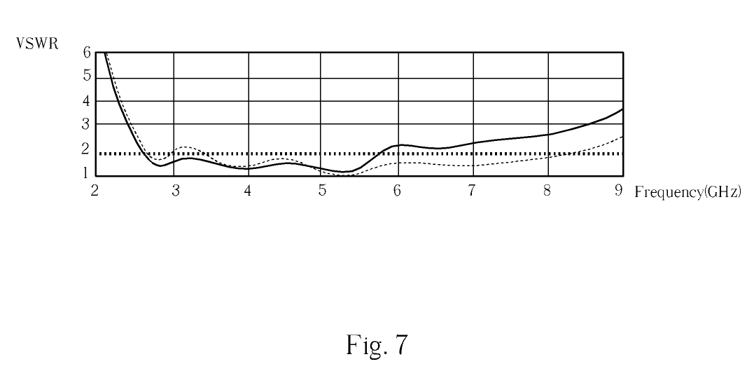

Please refer to FIG. 7 and FIG. 6. FIG. 7 is a diagram illustrating the VSWR of the flat miniaturized antenna 60 in FIG. 6. The horizontal axis represents frequency, and the vertical axis represents VSWR. As shown in FIG. 7, real line waveforms represent the VSWR when the joint of the first side 431 and the second side 432 of the third radiation plate 343 forms a right angle and its bandwidth fall from 2 GHz to 6 GHz, and dotted line waveforms represent the VSWR when the joint of the first side 631 and the second side 632 of the third radiation plate 643 forms an arc and its bandwidth fall from 2.6 GHz to 8.3 GHz. The flat miniaturized antenna 60 not only is satisfied with both Wi-Fi and Wi-Max but also could provide wider bandwidth to demands of wireless communication system.

The abovementioned embodiments are presented merely for describing the present invention, and in no way should be considered to be limitations of the scope of the present invention. In the abovementioned embodiments, the first radiation plate 341, the second radiation plate 342, and the third radiation plate are used for resonating the bandwidth of the first resonance mode (5 GHz-6 GHz), the bandwidth of the third resonance mode (3.3 GHz-3.8 GHz), and the bandwidth of the second resonance mode (2.3 GHz-2.7 GHz) individually, though, are not limited to this only. Bandwidths of different frequencies can be resonated by adjusting the length of the first radiation plate 341, the length of the second radiation plate 342, and the length of the third radiation plate 343. Furthermore, the first radiation plate 341 approximately parallels the first sheet 321 but is not restricted to this and can be varied by mechanism demands. The joint of the first side 631 and the second side 632 of the third radiation plate 643 can form a right angle, an oblique angle, or an arc and its shape and angle is not restricted.

From the above descriptions, the present invention provides the flat miniaturized antenna 30 operated in wide band. The flat miniaturized antenna 30 can resonate the bandwidth of the first resonance mode (5 GHz-6 GHz) through the first radiation plate 341, the bandwidth of the third resonance mode (3.3 GHz-3.8 GHz) through the second radiation plate 342, and the bandwidth of the second resonance mode (2.3 GHz-2.7 GHz) through the third radiation plate 343. All voltage gains fall can satisfy with demands of wireless communication system in frequencies adjacent to 2.5 GHz, 3.3 GHz, and 5 GHz-6 GHz. In other words, the flat miniaturized antenna 30 is satisfied with both Wi-Fi and Wi-Max. One antenna is integrated for two systems' use. The flat miniaturized antenna 30 has better impedance matching and can save space due to the included angle between the third radiation plate 343 and the second radiation plate 342 is 90 degrees. Furthermore, the flat miniaturized antenna 30 is capable of tallying with mechanisms and has increased capacitor effect for better impedance matching due to the first radiation plate 341 paralleling the first sheet 321.

Those skilled in the art will readily observe that numerous modifications and alterations of the device and method may be made while retaining the teachings of the invention. Accordingly, the above disclosure should be construed as limited only by the metes and bounds of the appended claims.

1. A flat miniaturized antenna operated in wide band comprising:
a substrate having a first sheet and a second sheet, the first sheet perpendicular to the second sheet and comprising a short point and a grounding point;
a radiation element installed on the first sheet, the radiation element comprising:
a first radiation plate approximately paralleling the first sheet;
a second radiation plate approximately paralleling the first sheet and extended in a direction opposite to the first radiation plate; and
a third radiation plate positioned between the second radiation plate and the first sheet and perpendicular to the second radiation plate, the third radiation plate approximately being an L shape, and having a first side coupled to the first radiation plate and to the second radiation plate and a second side;
a short circuit metal arm installed between the first radiation plate and the first sheet, the short circuit metal arm having a start terminal coupled to the first side and to the second side of the third radiation plate, and an end terminal coupled to the short point of the substrate; and
a feed element used for connecting the second side of the third radiation plate to the grounding point of the first sheet electrically.

2. The flat miniaturized antenna of claim 1 wherein the second side of the third radiation plate comprises a feed point, the feed point located adjacent to the first sheet and coupled to the grounding point of the first sheet through the feed element.

3. The flat miniaturized antenna of claim 1 wherein the substrate comprises dielectric material.

4. The flat miniaturized antenna of claim 1 wherein the substrate comprises magnetic material.

5. The flat miniaturized antenna of claim 1 wherein the substrate is coupled to a system ground terminal.

6. The flat miniaturized antenna of claim 1 wherein the radiation element is substantially composed of a single metal sheet.

7. The flat miniaturized antenna of claim 1 wherein the short circuit metal arm is substantially composed of a single metal sheet.

8. The flat miniaturized antenna of claim 1 wherein a length of the first radiation plate is smaller than a length of the second radiation plate.

9. The flat miniaturized antenna of claim 1 wherein a length of the second side of the third radiation plate is greater than a sum of a length of the second radiation plate and a length of the first side of the third radiation plate.

10. The flat miniaturized antenna of claim 1 wherein a sum of a length of the first radiation plate and a length of the first side of the third radiation plate is approximately one-fourth of a wavelength of a first resonance mode generated by the flat miniaturized antenna.

11. The flat miniaturized antenna of claim 1 wherein a sum of a length of the second radiation plate and a length of the first side of the third radiation plate is approximately one-fourth of a wavelength of a second resonance mode generated by the flat miniaturized antenna.

12. The flat miniaturized antenna of claim 1 wherein a length of the second side of the third radiation plate is approximately one-fourth of a wavelength of a third resonance mode generated by the flat miniaturized antenna.

13. The flat miniaturized antenna of claim 1 wherein a joint of the first side and the second side of the third radiation plate forms a right angle.

14. The flat miniaturized antenna of claim 1 wherein a joint of the first side and the second side of the third radiation plate forms an oblique angle.

15. The flat miniaturized antenna of claim 1 wherein a joint of the first side and the second side of the third radiation plate forms an arc.

16. The flat miniaturized antenna of claim 1 wherein the flat miniaturized antenna is installed in a wireless communication device.

17. The flat miniaturized antenna of claim 16 wherein the wireless communication device is a notebook computer.
